(19) United States
(12) Patent Application Publication
(10) Pub. No.: US 2017/0349088 A1
(43) Pub. Date: Dec. 7, 2017

(54) VEHICLE ILLUMINATION DEVICE

(71) Applicant: KABUSHIKI KAISHA TOKAI-RIKA-DENKI-SEISAKUSHO, Aichi (JP)

(72) Inventors: Kazuyuki YOKOYAMA, Aichi (JP); Masatsugu OHASHI, Aichi (JP); Masahiro ARAI, Aichi (JP)

(21) Appl. No.: 15/543,484

(22) PCT Filed: Dec. 17, 2015
(86) PCT No.: PCT/JP2015/085403

§ 371 Date: Jul. 13, 2017

(30) Foreign Application Priority Data
Jan. 20, 2015 (JP) 2015-008822

(51) Int. Cl. B60Q 1/24; B60Q 1/26; B60Q 1/50; F21S 8/10; F21V 31/03; G09F 21/04

(52) U.S. Cl. CPC B60Q 1/24; F21S 8/10; F21V 31/03; B60Q 1/26; B60Q 1/50; G09F 21/04

(57) ABSTRACT

In a vehicle door mirror device, a projection device projects a graphic from a graphic film. The projection device is inserted into a cap in a state in which a holding tube of the cap has been inserted into a through hole in a visor, and the holding tube is held between a peripheral face of the through hole and a protrusion portion of the projection device. The projection device is thus installed at the visor in a manner retained by the cap alone. This thereby enables easy installation of the projection device to the visor.

### TECHNICAL FIELD

The present invention relates to a vehicle illumination device that emits light.

### BACKGROUND ART

In a door mirror described in Japanese Patent Application Laid-Open (JP-A) No. 2010-173540, a camera is fixed to a door mirror body through a bracket.

In such door mirrors, it is desirable to enable easy installation of a camera to a door mirror body.

### SUMMARY OF INVENTION

### Technical Problem

In consideration of the above circumstances, an object of the present invention is to obtain a vehicle illumination device enabling easy installation of an illumination mechanism to an installation member.

### Solution to Problem

A vehicle illumination device of a first aspect of the present invention includes an installation member that is provided at a vehicle and that includes an insertion hole, an elastic body that is inserted into the insertion hole, and an illumination mechanism that emits light toward an outer side of the vehicle and that is installed at the installation member by elastically compressing the elastic body between the illumination mechanism and a peripheral face of the insertion hole such that the illumination mechanism is retained by the elastic body alone.

A vehicle illumination device of a second aspect of the present invention is the vehicle illumination device of the first aspect of the present invention, further including a groove that is provided at at least one of the elastic body or the illumination mechanism, and a suppressing portion that is housed in the groove, and that is elastically compressed between the elastic body and the illumination mechanism, so as to suppress incursion of water into the illumination mechanism from between the elastic body and the illumination mechanism.

A vehicle illumination device of a third aspect of the present invention is the vehicle illumination device of either the first aspect or the second aspect of the present invention, further including a suppressing portion that is disposed in the insertion hole, and that is elastically compressed between the elastic body and the illumination mechanism, so as to suppress incursion of water into the illumination mechanism from between the elastic body and the illumination mechanism.

### Advantageous Effects of Invention

In the vehicle illumination device of the first aspect of the present invention, the illumination mechanism is installed at the installation member provided at the vehicle, and the illumination mechanism emits light toward the outer side of the vehicle.

Note that the elastic body is inserted into the insertion hole provided at the installation member, and the illumination mechanism is installed at the installation member by elastically compressing the elastic body between the illumination mechanism and the peripheral face of the insertion hole such that the illumination mechanism is retained by the elastic body alone. This thereby enables easy installation of the illumination mechanism to the installation member.

In the vehicle illumination device of the second aspect of the present invention, the suppressing portion is elastically compressed between the elastic body and the illumination mechanism, so as to suppress incursion of water into the illumination mechanism from between the elastic body and the illumination mechanism.

Note that the groove is provided at at least one of the elastic body or the illumination mechanism, and the suppressing portion is housed in the groove. Accordingly, an incursion route of water into the illumination mechanism from between the elastic body and the illumination mechanism can be lengthened, thereby enabling the incursion of water into the illumination mechanism to be effectively suppressed.

In the vehicle illumination device of the third aspect of the present invention, the suppressing portion is elastically compressed between the elastic body and the illumination mechanism, so as to suppress incursion of water into the illumination mechanism from between the elastic body and the illumination mechanism.

Note that the suppressing portion is disposed in the insertion hole. Accordingly, the suppressing portion can be elastically compressed by a portion of the elastic body that is elastically compressed between the illumination mechanism and the peripheral face of the insertion hole, thereby enabling the incursion of water into the illumination mechanism to be effectively suppressed.

### BRIEF DESCRIPTION OF DRAWINGS

FIG. 1 is a face-on view illustrating a vehicle door mirror device according to an exemplary embodiment of the present invention, as viewed from the vehicle rear.

FIG. 2 is a face-on view illustrating relevant portions of the vehicle door mirror device according to the exemplary embodiment of the present invention.

FIG. 3 is a lower face view illustrating relevant portions of the vehicle door mirror device according to the exemplary embodiment of the present invention, as viewed from below.

FIG. 4 is an exploded perspective view illustrating relevant portions of the vehicle door mirror device according to the exemplary embodiment of the present invention, as viewed from an upper side.

FIG. 5 is a cross-section (cross-section taken along line 5-5 in FIG. 3) illustrating relevant portions of the vehicle door mirror device according to the exemplary embodiment of the present invention.

FIG. 6 is perspective view illustrating a cap of the vehicle door mirror device according to the exemplary embodiment of the present invention, as viewed from the upper side.

### DESCRIPTION OF EMBODIMENTS

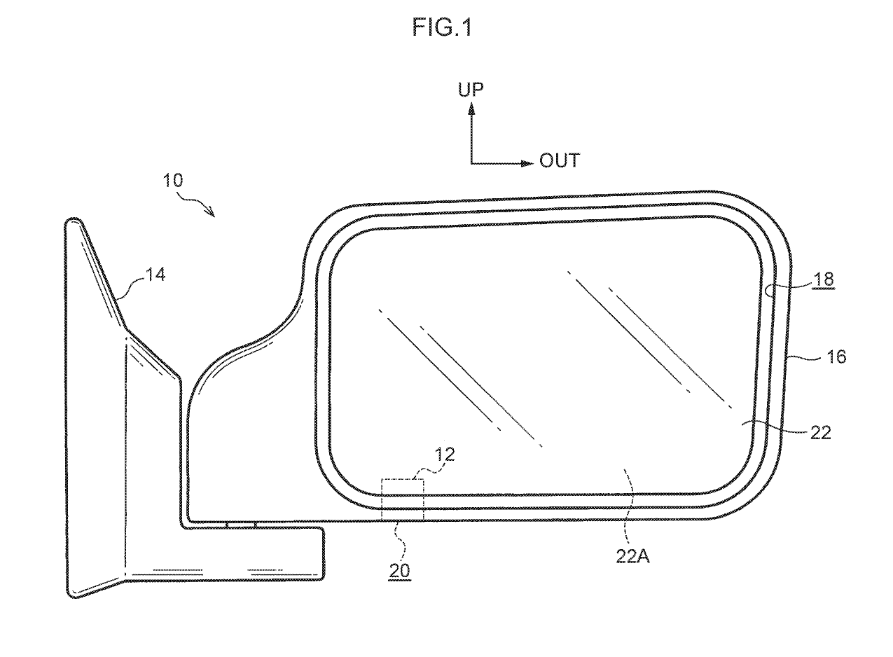

FIG. 1 is a face-on view illustrating a vehicle door mirror device 10 according to an exemplary embodiment of the present invention, as viewed from the vehicle rear. Note that in the drawings, the arrow OUT indicates the vehicle width direction outside (vehicle right), and the arrow UP indicates upwards.

The vehicle door mirror device 10 according to the present exemplary embodiment is provided at a vehicle outside of an up-down direction intermediate portion and vehicle front side end of a side door (specifically, a front side door), serving as a vehicle door.

As illustrated in FIG. 1, the vehicle door mirror device 10 includes a stay 14, serving as a fixing member. A vehicle width direction inside end of the stay 14 is fixed to the side door (vehicle body side), thereby fixing the vehicle door mirror device 10 to the side door.

A substantially rectangular container-shaped visor 16 that is made from resin and serves as an installation member is supported on a vehicle width direction outside portion of the stay 14. The visor 16 is disposed at the vehicle width direction outside of the stay 14. A substantially rectangular shaped opening 18 is formed penetrating a vehicle rear side wall of the visor 16, and the opening 18 is open toward the vehicle rear side at the inside of the visor 16.

A substantially circular shaped through hole 20, serving as an insertion hole, is formed penetrating a lower wall of the visor 16. The through hole 20 is open toward the lower side at the inside of the visor 16. An inside face (upper side face) of the lower wall of the visor 16 is integrally formed with a columnar restriction projection 16A configuring a restriction means at the periphery of the through hole 20. The restriction projection 16A extends in a radial direction of the through hole 20.

A substantially rectangular plate shaped mirror 22, serving as a visual recognition means, is housed inside the visor 16 in the vicinity of the opening 18. The mirror 22 substantially closes off the opening 18. A mirror surface 22A of the mirror 22 faces toward the vehicle rear side, such that the mirror 22 enables visual recognition rearward of the vehicle by an occupant of the vehicle (in particular, the driver), thus assisting the occupant with visual recognition.

A projection device 12, serving as an illumination mechanism, is housed at an upper side of the through hole 20 inside the visor 16.

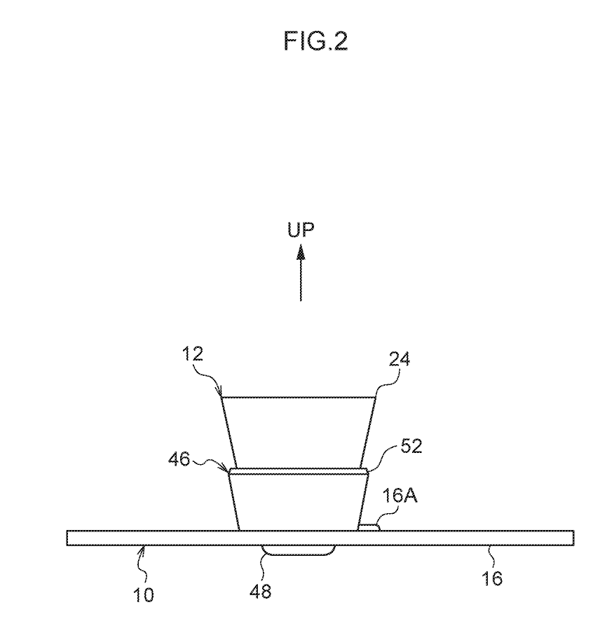

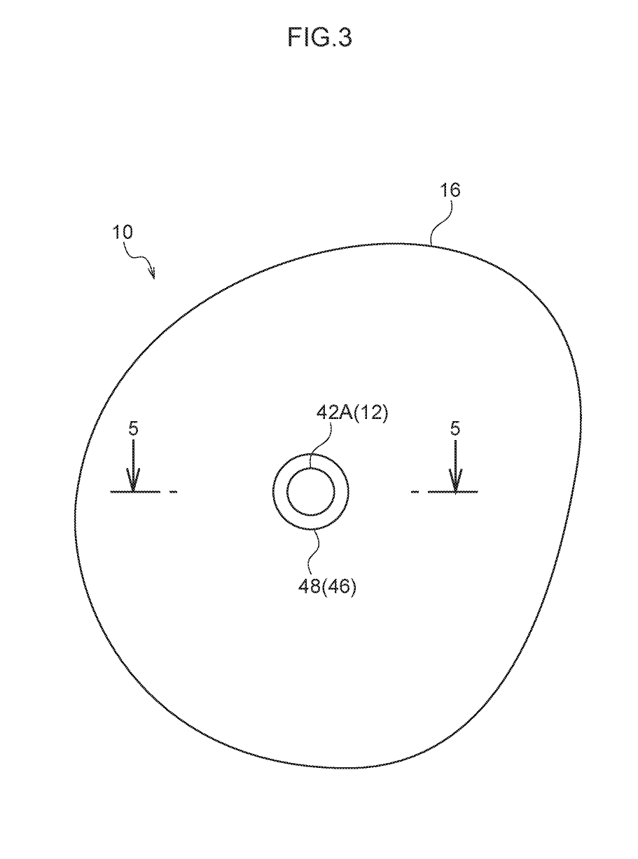

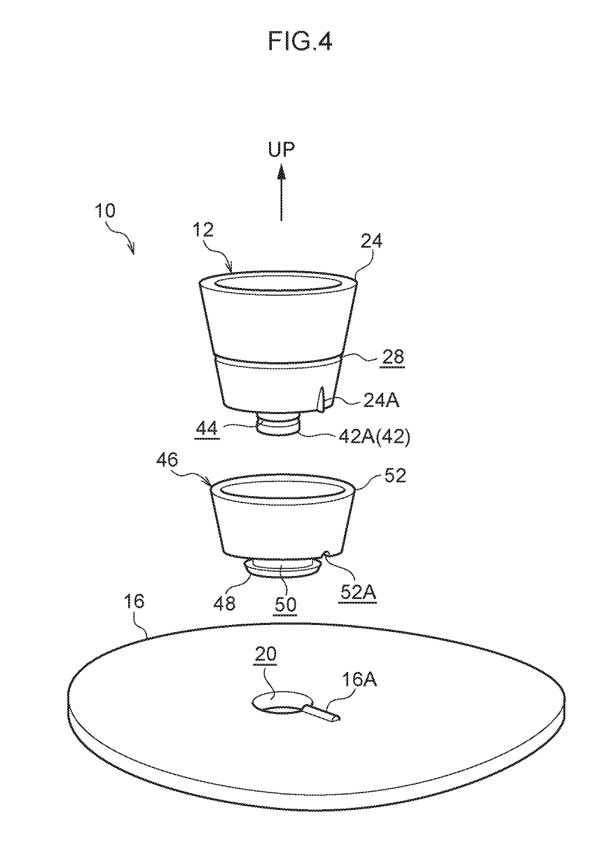

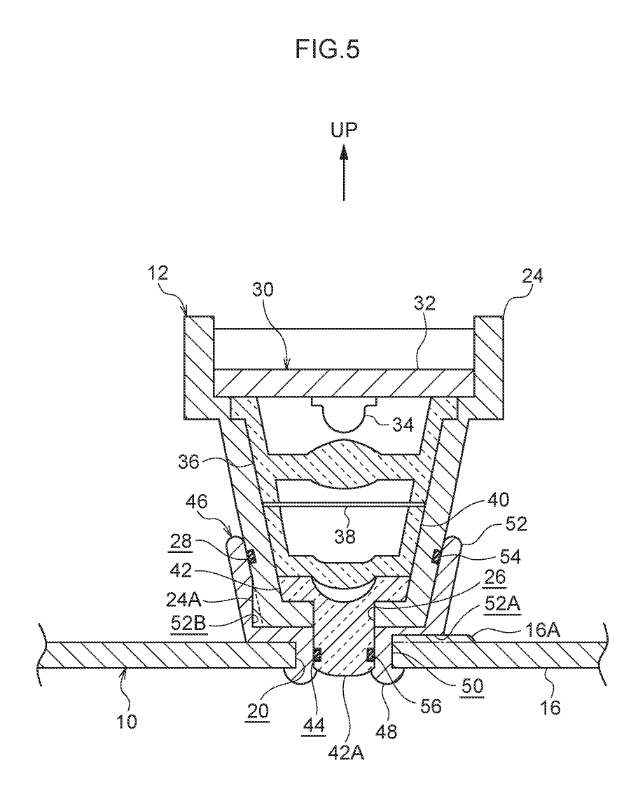

As illustrated in FIG. 2 to FIG. 5, the projection device 12 is provided with a case 24, serving as a housing body, that is made from resin and substantially has the shape of an inverted circular frustum-shaped container. Light cannot pass through the case 24. A circular exposure hole 26 is coaxially formed penetrating a lower wall (bottom wall) of the case 24. The outer periphery of the case 24 is closed off, with the exception of a portion corresponding to the exposure hole 26.

A columnar locking projection 24A configuring a locking means is integrally formed at a lower end portion of an outer peripheral face of the case 24. The locking projection 24A extends in the axial direction of the case 24. A lower portion of the outer peripheral face of the case 24 is formed with a suppressing recess 28, serving as a groove (first groove), running around the entire periphery of the case 24 at an upper side of the locking projection 24A. The suppressing recess 28 is open toward the peripheral outside of the case 24.

A projection mechanism 30, serving as an illumination means (projection means) is provided inside the case 24.

The projection mechanism 30 is provided with a rectangular plate shaped circuit board 32, serving as a supply body. The circuit board 32 is fixed inside an upper end portion of the case 24. The circuit board 32 is electrically connected to a power source (not illustrated in the drawings).

An LED 34, serving as a light source, is fixed to a lower face of the circuit board 32. The LED 34 is electrically connected to the circuit board 32. The LED 34 is housed inside the upper end portion of the case 24, and the LED 34 is disposed on an axial center line of the case 24.

Inside the case 24, a collimator lens 36 that has a substantially H-shaped cross-section profile and that serves as a first lens is fixed at a lower side of the circuit board 32. The collimator lens 36 is disposed coaxially with the case 24.

Inside the case 24, a graphic film 38 in the shape of a circular sheet and serving as an image member is fixed at a lower side of the collimator lens 36. The graphic film 38 is disposed coaxially with the case 24. A graphic such as a symbol (not illustrated in the drawings) that serves as an image is provided at a central side portion of the graphic film 38. Light is capable of passing through the graphic film 38.

Inside the case 24, a first image-forming lens 40 that has a substantially U-shaped cross-section profile and that serves as a second lens is fixed at a lower side of the graphic film 38. The first image-forming lens 40 is disposed coaxially with the case 24.

Inside the case 24, a second image-forming lens 42 that has a substantially T-shaped cross-section profile and that serves as a third lens is fixed at a lower side of the first image-forming lens 40. The second image-forming lens 42 is disposed coaxially with the case 24. A protrusion portion 42A that has a substantially circular columnar shape and that serves as an insertion portion is coaxially formed at a central side portion of the second image-forming lens 42. The protrusion portion 42A protrudes out toward the lower side. The protrusion portion 42A is inserted through and fitted together with the exposure hole 26 in the lower wall of the case 24, and the protrusion portion 42A protrudes out to the lower side of the case 24. An outer peripheral face of the protrusion portion 42A is formed with a sealing recess 44 serving as a groove (second groove), running around the entire periphery of the protrusion portion 42A at the lower side of the case 24. The sealing recess 44 opens toward the peripheral outside of the protrusion portion 42A.

The projection device 12 is installed at the visor 16 using a substantially circular cylinder shaped cap 46, serving as an elastic body. The cap 46 is, for example, made of rubber, and is elastic and has sealing properties.

A lower side portion of the cap 46 configures a substantially circular cylinder shaped holding tube 48, serving as a holding portion. The holding tube 48 is disposed coaxially with the cap 46. An insertion recess 50 with a substantially rectangular shaped cross-section is formed running around the entirety of an outer peripheral face of the holding tube 48, with the exception of at a lower end portion. The insertion recess 50 opens toward the peripheral outside of the holding tube 48.

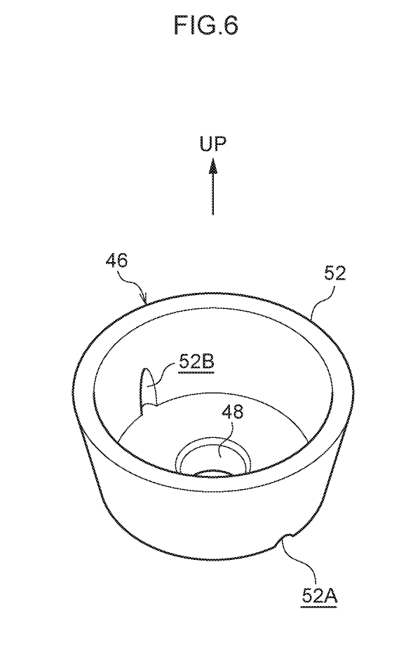

An upper side portion of the cap 46 is configured by a fitting tube 52 substantially shaped as an inverted circular frustum-shaped tube with a bottom, and serving as a fitting portion. The fitting tube 52 is disposed coaxially with the cap 46, and the interior of the fitting tube 52 is in communication with the interior of the holding tube 48. A lower face of the fitting tube 52 is formed with a restriction recess 52A configuring a restriction means in the vicinity of the holding tube 48. The restriction recess 52A is open toward the lower side and extends in a radial direction of the cap 46. An locking recess 52B (see FIG. 6) configuring the locking means is formed at a lower end portion of an inner peripheral face of the fitting tube 52. The locking recess 52B opens toward the peripheral inside of the fitting tube 52, and extends along the axial direction of the cap 46.

The holding tube 48 of the cap 46 is coaxially inserted through (inserted into) the through hole 20 in the visor 16, and a peripheral portion of the through hole 20 in the visor 16 is press-fitted into the insertion recess 50 of the holding tube 48. Accordingly, the holding tube 48 is elastically stretched in its axial direction by the visor 16, and the outer peripheral face of the holding tube 48 is elastically compressed toward its radial direction inside by a peripheral face of the through hole 20. The restriction projection 16A of the visor 16 fits into the restriction recess 52A in the fitting tube 52 of the cap 46, thereby restricting peripheral direction rotation of the cap 46, and thus positioning the cap 46 in the peripheral direction.

The projection device 12 is coaxially inserted inside the cap 46.

The protrusion portion 42A of the second image-forming lens 42 of the projection device 12 is press-fitted into the holding tube 48 of the cap 46, such that the inner peripheral face of the holding tube 48 is elastically stretched toward the radial direction outside by the peripheral face of the protrusion portion 42A. Moreover, the sealing recess 44 of the protrusion portion 42A is disposed at an axial direction central portion of the through hole 20 in the visor 16.

A lower portion of the case 24 of the projection device 12 is press-fitted inside the fitting tube 52 of the cap 46, such that the fitting tube 52 is elastically stretched toward the radial direction outside by the outer peripheral face of the case 24. The locking projection 24A of the case 24 is fitted into the locking recess 52B of the fitting tube 52 of the cap 46, thereby locking peripheral direction rotation of the projection device 12, and thus positioning the projection device 12 in the peripheral direction.

A circular ring shaped suppressing ring 54, serving as a suppressing portion (first suppressing portion), is housed in the suppressing recess 28 of the case 24. The suppressing ring 54 is, for example, made from rubber, and is elastic and has sealing properties. The suppressing ring 54 has lower rigidity than the fitting tube 52 of the cap 46, and the suppressing ring 54 is held and elastically compressed between the case 24 and the fitting tube 52 so as to form a seal between the case 24 and the fitting tube 52.

A circular ring shaped sealing ring 56 serving as a suppressing portion (second suppressing portion) is housed in the sealing recess 44 of the protrusion portion 42A. The sealing ring 56 is, for example, made from rubber, and is elastic and has sealing properties. The sealing ring 56 has lower rigidity than the holding tube 48 of the cap 46, and the sealing ring 56 is held and elastically compressed between the protrusion portion 42A and the holding tube 48 so as to form a seal between the protrusion portion 42A and the holding tube 48.

Next, explanation follows regarding operation of the present exemplary embodiment.

In the projection device 12 of the vehicle door mirror device 10 configured as described above, electric power from the power source is supplied to the LED 34 through the circuit board 32, and the LED 34 radiates light toward the lower side such that the light passes through (travels through) the collimator lens 36, the graphic film 38, the first image-forming lens 40, and the second image-forming lens 42 (the exposure hole 26 in the case 24, the inside of the holding tube 48 of the cap 46, and the through hole 20 in the visor 16). The graphic of the graphic film 38 is projected (beamed) onto the ground at the outer side of the vehicle (the light is shone onto the ground at the outer side of the vehicle).

Note that the projection device 12 is inserted into the cap 46 in a state in which the holding tube 48 of the cap 46 is inserted into the through hole 20 in the visor 16. Accordingly, the holding tube 48 is elastically compressed between the peripheral face of the through hole 20 and the protrusion portion 42A of the second image-forming lens 42 of the projection device 12, and the fitting tube 52 of the cap 46 is elastically stretched by the case 24 of the projection device 12. The holding tube 48 is thus held between the peripheral face of the through hole 20 and the protrusion portion 42A, thereby installing the cap 46 so as to be retained by the visor 16. Moreover, the protrusion portion 42A is retained in the holding tube 48, and the case 24 is retained in the fitting tube 52, such that the projection device 12 is installed at the visor 16 in a manner retained by the cap 46 alone.

Accordingly, after the cap 46 (holding tube 48) has been inserted through the through hole 20 in the visor 16, the projection device 12 can be installed at the visor 16 by merely inserting the projection device 12 (the protrusion portion 42A and the case 24) into the cap 46, thus enabling easy installation of the projection device 12 to the visor 16.

Moreover, the projection device 12 can be installed at the visor 16 using the cap 46 alone. This thereby enables a simple installation structure of the projection device 12 to the visor 16, enabling space to be saved, and enabling a reduction in the number of components.

Moreover, the suppressing ring 54 is elastically compressed between the case 24 of the projection device 12 and the fitting tube 52 of the cap 46, such that the suppressing ring 54 forms a seal between the case 24 and the fitting tube 52, thereby suppressing the incursion of water into the case 24 between the case 24 and the fitting tube 52 and through the exposure hole 26 in the case 24.

Moreover, the sealing ring 56 is elastically compressed between the protrusion portion 42A of the projection device 12 and the holding tube 48 of the cap 46, such that the sealing ring 56 forms a seal between the protrusion portion 42A and the holding tube 48, thereby suppressing the incursion of water into the case 24 between the protrusion portion 42A and the holding tube 48 and through the exposure hole 26 in the case 24.

Note that the suppressing ring 54 is housed in the suppressing recess 28 of the projection device 12 (case 24), and the sealing ring 56 is housed in the sealing recess 44 of the projection device 12 (protrusion portion 42A). Accordingly, an incursion route of water into the case 24 between the case 24 and the fitting tube 52 and through the exposure hole 26 can be lengthened, and an incursion route of water into the case 24 between the protrusion portion 42A and the holding tube 48 and through the exposure hole 26 can be lengthened, thereby enabling the incursion of water into the case 24 to be effectively suppressed.

Moreover, the sealing recess 44 of the protrusion portion 42A is disposed inside the through hole 20 in the visor 16, and the sealing ring 56 is also disposed inside the through hole 20. Accordingly, the sealing ring 56 can be elastically compressed by a portion of the holding tube 48 that is elastically compressed between the protrusion portion 42A and the peripheral face of the through hole 20, enabling the sealing ring 56 to be effectively elastically compressed, thereby enabling the incursion of water into the case 24 between the protrusion portion 42A and the holding tube 48 and through the exposure hole 26 to be even more effectively suppressed.

Moreover, the restriction projection 16A of the visor 16 is fitted into the restriction recess 52A of the fitting tube 52 of the cap 46, thereby restricting peripheral direction rotation of the cap 46, and positioning the cap 46 in the peripheral direction. Moreover, the locking projection 24A of the case 24 of the projection device 12 is fitted into the locking recess 52B of the fitting tube 52, thereby locking peripheral direction rotation of the projection device 12, and positioning the projection device 12 in the peripheral direction. Accordingly, the peripheral direction position of the graphic film 38 in the projection device 12 can be suppressed from slipping, enabling the orientation of the graphic of the graphic film 38 that is projected onto the ground at the outer side of the vehicle to be suppressed from slipping.

Note that in the present exemplary embodiment, a single restriction recess 52A and a single locking recess 52B are provided at the fitting tube 52 of the cap 46. However, plural of at least one element out of the restriction recesses 52A or the locking recesses 52B may be provided at the fitting tube 52 of the cap 46 in the peripheral direction. So doing would enable selection of the restriction recess 52A into which the restriction projection 16A of the visor 16 is inserted, thus enabling adjustment of the peripheral direction position of the cap 46 with respect to the visor 16, and/or enable selection of the locking recess 52B into which the locking projection 24A of the projection device 12 is fitted, thus enabling adjustment of the peripheral direction position of the projection device 12 with respect to the cap 46. This thereby enables adjustment of the peripheral direction position of the projection device 12 with respect to the visor 16, and enables adjustment of the orientation of the graphic of the graphic film 38 that is projected onto the ground at the outer side of the vehicle.

Moreover, in the present exemplary embodiment, the suppressing recess 28 is provided at the case 24 of the projection device 12. However, it is sufficient that the suppressing recess 28 be provided at at least one of the case 24 of the projection device 12 or the fitting tube 52 of the cap 46.

Moreover, in the present exemplary embodiment, the sealing recess 44 is provided at the protrusion portion 42A of the projection device 12. However, it is sufficient that the sealing recess 44 be provided at at least one of the protrusion portion 42A of the projection device 12 or the holding tube 48 of the cap 46.

Moreover, in the present exemplary embodiment, the suppressing ring 54 and the sealing ring 56 are configured as separate members to the cap 46. However, at least one of the suppressing ring 54 or the sealing ring 56 may be integrally provided at the cap 46.

Moreover, in the present exemplary embodiment, the projection device 12 is provided with the graphic film 38. However, the projection device 12 (illumination mechanism) does not have to be provided with the graphic film 38.

Moreover, in the present exemplary embodiment, the projection device 12 is installed at the visor 16 of the vehicle door mirror device 10. However, it is sufficient that the projection device 12 be installed at an installation member that can be exposed at the outer side of the vehicle such that light can be emitted toward the outer side of the vehicle. For example, the projection device 12 may be installed at a door (including a door handle) of the vehicle. The projection device 12 may even be installed at a location on the vehicle cabin side of a door, as long as the projection device 12 is capable of emitting light toward the outer side of the vehicle when the door has been opened.

The disclosure of Japanese Patent Application No. 2015-8822, filed on Jan. 20, 2015, is incorporated in its entirety by reference herein.

### EXPLANATION OF THE REFERENCE NUMERALS

10 vehicle door mirror device (vehicle illumination device)
12 projection device (illumination mechanism)
16 visor (installation member)
20 through hole (insertion hole)
28 suppressing recess (groove)
44 sealing recess (groove)
46 cap (elastic body)
54 suppressing ring (suppressing portion)
56 sealing ring (suppressing portion)
   cm 1-7. (canceled)

8. A vehicle illumination device, comprising:
an installation member that is provided at a vehicle and that includes an insertion hole;
an elastic body that is inserted into the insertion hole;
an illumination mechanism that emits light toward an outer side of the vehicle and that is installed at the installation member by elastically compressing the elastic body between the illumination mechanism and a peripheral face of the insertion hole such that the illumination mechanism is retained by the elastic body alone;
a groove that is provided at at least one of the elastic body or the illumination mechanism; and
a suppressing portion that is housed in the groove, and that is elastically compressed between the elastic body and the illumination mechanism, so as to suppress incursion of water into the illumination mechanism from between the elastic body and the illumination mechanism.

9. A vehicle illumination device comprising:
an installation member that is provided at a vehicle and that includes an insertion hole;
an elastic body that is inserted into the insertion hole;
an illumination mechanism that emits light toward an outer side of the vehicle and that is installed at the installation member by elastically compressing the elastic body between the illumination mechanism and a peripheral face of the insertion hole such that the illumination mechanism is retained by the elastic body alone; and
a suppressing portion that is disposed in the insertion hole, and that is elastically compressed between the elastic body and the illumination mechanism, so as to suppress incursion of water into the illumination mechanism from between the elastic body and the illumination mechanism.

10. The vehicle illumination device of claim 8, wherein rotation of the elastic body with respect to the installation member is restricted.

11. The vehicle illumination device of claim 10, wherein a rotation position of the elastic body with respect to the installation member is selectable.

12. The vehicle illumination device of claim 9, wherein rotation of the illumination mechanism with respect to the elastic body is locked.

13. The vehicle illumination device of claim 12, wherein a rotation position of the illumination mechanism with respect to the elastic body is selectable.
